(19) United States
(12) Patent Application Publication
(10) Pub. No.: US 2002/0001582 A1
(43) Pub. Date: Jan. 3, 2002

(54) Methods and compositions for inhibiting microbial growth

(76) Inventors: Edward A. Charter, Abbotsford (CA); Yun Cai Gao, Abbotsford (CA); Craig I. Maclean, Seattle, WA (US)

Correspondence Address: Robert E. Krebs, Esq., BURNS, DOANE, SWECKER & MATHIS, L.L.P., P.O. Box 1404, Alexandria, VA, 22313-1404, US

(21) Appl. No.: 09/902,228

(22) Filed: Jul. 9, 2001

Related U.S. Application Data
(62) Division of application No. 09/553,378, filed on Apr. 20, 2000, now abandoned.
(60) Provisional application No. 60/146,310, filed on Jul. 28, 1999.
(60) Provisional application No. 60/130,437, filed on Apr. 21, 1999.

(51) Int. Cl. A01N 65/00; A01N 29/12

(52) U.S. Cl. 424/94.6; 424/745; 514/749; 424/130.1

(57) ABSTRACT

This invention relates to a method for the inhibition of the growth of undesirable microorganisms on fruit, vegetable, turfgrass and other plant systems by the application of specific enzymes either alone or in combination with fungicidally active agents.

### CROSS-REFERENCE TO RELATED APPLICATIONS

This application claims the benefit of U.S. Provisional Application No. 60/146,310 filed Jul. 28, 1999 and U.S. Provisional Application No. 601130/437 filed Apr. 21, 1999, both of which are incorporated by reference herein in their entirety.

### BACKGROUND OF THE INVENTION

1. Field of the Invention

This invention relates to a method for the inhibition of the growth of fungi or protists on fruit, vegetable, turfgrass and other plant systems by the application of specific enzymes either alone or in combination with other fungicidally active agents. This invention also relates to a method for the inhibition of the growth of fungi during the malting process of beer by the application of specific enzymes.

2. References

The following publications are cited in this application as superscript numbers:

1. Bierbaum, G. and H. G. Sahl, (1991). “Induction of autolysis of Staphylococcus simulans 22 by Pep5 and nisin and influence of the cationic peptides on the activity of the autolytic enzymes” In Nisin and Novel Lantibíotics ed. Jung, G. and H. G. Sahl, pp. 347-358. Leiden: ESCOM.

2. Christensen, B. et al., (1988). “Channe-forming properties of cecropins and related model compounds incorporated into planar lipid membranes.” Proceedings of the National Academy of Sciences of the USA. 85:5072-5076.

3. Durance, T. D., (1994). “Isolation and thermal stability of lysozyme and avidin”. In Egg Uses and Processing Technologies—New Development. Edited by J. S. Sim and S. Nakai. CAB International, Wallingford Oxon, UK.

4. Green, N. M., (1963). “Avidin: The use of [¹⁴C] biotin for kinetic studies and for assay”. Biochem J., 89:585-591.

5. Hadwinger, L. A., et al., (1984). “Chitosan, a natural regulation in plant-fungal pathogen interactions increases crop yield.” Chitin, Chitosan and Related Enzymes. Edited by J. P. Zikakis. pp. 140-145. Academic Press.

Inc. Orlando, Fla.

6. Hugo, W. B., (1978). “Membrane-active antimicrobial drugs—reappraisal of their mode of action in the light of the chemosmotic theory.” International Journal of Pharmaceutics. 1: 127-131.

7. Hurst, A., 1998. “Nisin” Adv. Appli. Microbiol. 27:85-122.

8. Johansen, C., et al., (1995) “Antibacterial effect of protamine assayed by impedimetry” Journal of Applied Bacteriology, 78:297-303.

9. Jolles, P and J. Jolles, (1984). “What's new in lysozyme research” . Mol. and Cell Biochem 63:165-189.

10. Kagan, B. L., et al., (1990). “Antimicrobial defensin peptides from voltage-dependent ion-permeable channels in planar lipid bilayer membranes.” Proceedings of the National Academy of Science of the USA. 87:210-214.

11. Korpela et al, (1981) “Biotin binding proteins in eggs of oviparous vertebrates”. Experimentia. 37:1065-1066.

12. Matsudomi, N. et al., (1994). “Emulsifying and bactericidal properties of a protamine-galactomannan conjugate prepared by dry heating.” Journal of Food Science. 59(2): 428-431.

13. Padgett, T., et al., (1998). “Incorporation of food-grade antimicrobial compounds into biodegradable packaging films” Journal of Food Protection. 61(10)1330-1335.

14. Proctor, V. A. and F. E. Cunningham, 1988. The chemistry of lysozyme and its use as a food preservative and a pharmaceutical. CRC Critical Rev. Food Science 26(4):359-395.

15. Shima S., H. et al., (1984). “Antimicrobial action of ε-Poly-L-Lisine” The Journal of Antibiotics. XXXVII( 1): 1449-1455.

16. Shugar, D., (1952). Biochimica et Biophysica Acta. 8:302-309.

17. Uyttendaele, M. and J. Debevere, (1994). “Evaluation of the antimicrobial activity of protamine” Food Microbiology 11:417-427.

18. Ueckert, J. E., et al., (1998). “Synergistic antibacterial action of heat in combination with nisin and magainin II amide”. J. of Applied Microbiology 85:487-494.

19. Wang, G. H., (1992) “Inhibition and inactivation of five species of foodborne pathogens by chitosan” J. Food Protection, 55(11):916-919.

20. Barone, F. E. and Tansey, M. R. “Isolation, purification, identification, synthesis and kinetics of activity of the anticandial comoponent of Allium sativum and a hypothesis for its mode of action,” Mycologia (1977) 69:793

21. Conner and Beuchat, “Inhibitory effect of plant oleoresins on yeasts,” Microbial Associations and Interactions in Food, Kiss et al. eds., Hungarian Academy Science of Budapest, (1984) 447-451.

22. Conner, “Inhibitory effects of essential oils and lieoresins from plants on food spoilage yeasts,” M. S. Thesis, University of Georgia, Athens, (1983).

23. Conner, Naturally Occurring Compounds in Antimicrobials in Foods, Davidson, et al. eds. Marcel Dekker, Inc., New York, (1993).

24. Farrell, Spices Condiments and Seasonings, AVI Publishing, Westport, Conn. (1985).

25. Shelef, et al., “Sensitivity of some common foodborne bacteria to the spices sage, rosemary, and allspice,” J. Food Sci., (1980) 45:1042.

26. Willis, “Enzyme inhibition by allicin, the active principle of garlic,” Biochemistry (1956) 63:514.

All of the above publications are herein incorporated by reference in their entirety to the same extent as if each individual publication was specifically and individually indicated to be incorporated by reference in its entirety.

### State of the Art

The use of certain lytic enzymes in plant protection has previously been described.

The use of microbial enzyme preparations from Trichoderma species as a agricultural fungicide for application to plants is discussed in International Patent Application No. WO90/03732.

The application of a agricultural composition containing a ruminant lysozyme to plants, cut flowers, fruits, seed and other plant tissues which are infected with one or more bacterial plant pathogens in order to make the plants less susceptible or resistant to diseases caused by bacterial plant pathogens is discussed in U.S. Pat. No. 5,422,108.

Lysozymes (muramidase: mucopeptide N-acetylmucamoylhydrolase; 1,4-β-N acetylhexosaminodase, E.C. 3.2.1.17) are mucolytic enzymes which have been isolated from various sources and are well characterized. Egg white lysozyme is an enzyme that consists of 129 amino acids, cross-linked by 4 disulfide bridges (Jolles and Jolles 1984). Its molecular weight is approximately 14,300 to 14,600 daltons. The isoelectric point is pH 10.5-10.7. This polypeptide has muramidase and chitinase activity that degrades bacterial and yeast cell walls.

Avidin is a basic egg white tetrameric glycoprotein made up of four identical polypeptide subunits. The amino acid sequence of an avidin subunit contains approximately 128-129 amino acids, with alanine and glutamate at the amino and carboxyl ends, respectively, with a uncharacterized carbohydrate moiety. The molecular weight of the entire molecule is about 67,000 daltons. Each subunit has an intrachain disulphide bond (Korpela 1984). Avidin has a strong and specific affinity for the vitamin biotin and binds four molecules of biotin, one per subunit. The avidin-biotin interaction is characterized by a dissociation constant of approximately 10⁻¹⁵ M, making it one of the strongest non-covalent ligand protein interactions known (Green, 1963). Lysozyme and avidin can be isolated together from the egg white (Durance, 1994).

Polylysine has a structural formula as shown below, in which units of L-lysine as an essential amino acid link together straightly:

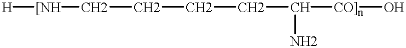

Shima et al (1984) suggested the mode of action of ε-polylysine is its adsorption to the bacterial cell surface. Polylysine is reported to have the ability to inhibit propagation of various microorganisms over a wide a range of pH. It has good heat stability and is readily soluble in water.

Protamines are basic proteins with high arginine content, usually found in association with DNA of spermatozoan nuclei of fish, birds, mammals, etc. (Johansen et al, 1995; Matsudomi et al, 1994; Uyttendaele and Debevere, 1994). The pI is pH 10-11. The mechanism of the antibacterial action of protamines is not known, but it has been suggested that they form a channel in the cytoplasmic membrane, thus uncoupling electron transport and causing leakage (Kagan et al, 1990; Christensen et al, 1988; Hugo 1978). It has also been proposed that they induce autolysis due to activation of the autolytic enzymes (Bierbaum and Sahl, 1991).

Chitosan is a polymer composed of glucosamine residues linked by β1-4 glucosidic bonds (Wang, 1992). It is a deacetylated derivative of chitin, which is the structural polymer of the exoskeleton of shellfish. There are broad prospects for applying chitin and chitosan in numerous fields such as medicine, environmental protection, textiles, papermaking and the food industry. It has been reported that chitosan inhibits the germination and growth of plant pathogenic Fusarium solani (Hadwinger et al, 1984). Wang (1992) claims that chitosan can inhibit five species of foodborne pathogens including S. aureus, E. coli., Y enterocolitica, L. monocytogenes and S. typhimurium.

Nisin is an antibacterial polypeptide produced by Lactococcus lactis subspecies lactis. with a molecular weight of 3,510 Daltons (Padgett et al, 1998). It broadly inhibits gram-positive bacteria and sporeformers (Hurst 1981). Nisin is currently used commercially as a biopreservative in processed cheese, dairy products, milk and canned foods (Ueckert et al, 1998). In the United States, nisin is approved for use in liquid whole egg and pasteurized cheese spreads (Padgett et al, 1998). The mode of action of nisin is believed to be disruption of membrane function induced by pore formation in the bacterial membrane and subsequent leakage of cellular material (Ueckert et al, 1998).

### SUMMARY OF THE INVENTION

In view of the foregoing limitations and shortcomings of the prior art methods of inhibiting growth of fungi or protists on plants, and in the malting of beer, it is apparent that there still exists a need in the art for methods and compositions for inhibiting the growth of fungi.

This invention is directed to a method for treating plants, plant tissues and seeds that are infected with one or more fungi or protist pathogens comprising contacting said plants, tissues and seeds with an effective amount of a fungicidal composition comprising avidin, wherein the avidin in said amount is effective in inhibiting or eradicating said fungi or protist pathogens. The fungicidal composition may further comprise an effective amount of a compound selected from the group consisting of lysozyme, ovotransferrin, chicken immunoglobulins, chitosan, polylysine, protamine, nisin, EDTA, rosemary, cinnemaldehyde, allicin and eugenol.

This invention is directed to a method for treating plants, plant tissues and seeds that are infected with one or more fungi or protist pathogens comprising contacting said plants, tissues and seeds with an effective amount of a fungicidal composition comprising polylysine, wherein the polylysine in said amount is effective in inhibiting or eradicating said fungi or protist pathogens. The fungicidal composition may further comprise an effective amount of a compound selected from the group consisting of avidin, lysozyme, ovotransferrin, chicken immunoglobulins, chitosan, protamine, nisin, EDTA, rosemary, cinnemaldehyde, allicin and eugenol.

This invention is directed to a method for treating plants, plant tissues and seeds that are infected with one or more fungi or protist pathogens comprising contacting said plants, tissues and seeds with an effective amount of a fungicidal composition comprising egg white lysozyme, wherein the lysozyme in said amount is effective in inhibiting or eradicating said fungi or protist pathogens. The fungicidal composition may further comprise an effective amount of a compound selected from the group consisting of lysozyme, ovotransferrin, chicken immunoglobulins, chitosan, polylysine, protamine, nisin, EDTA, rosemary, cinnemaldehyde, allicin and eugenol.

This invention is further directed to a method for preventing fungal or protist infection in plants, plant tissues and seeds comprising contacting said plants, tissues and seeds with an effective amount of a fungicidal composition comprising egg white lysozyme, wherein the lysozyme in said amount is effective to prevent fungal or protist infection. The fungicidal composition may further comprise an effective amount of a compound selected from the group consisting of lysozyme, ovotransferrin, chicken immunoglobulins, chitosan, polylysine, protamine, nisin, EDTA, rosemary, cinnemaldehyde,-allicin and eugenol.

This invention is further directed to a method for preventing fungal or protist infection in plants, plant tissues and seeds comprising contacting said plants, tissues and seeds with an effective amount of a fungicidal composition comprising avidin, wherein the avidin in said amount is effective to prevent said fungal or protist infection. The fungicidal composition may further comprise an effective amount of a compound selected from the group consisting of lysozyme, ovotransferrin, chicken immunoglobulins, chitosan, polylysine, protamine, nisin, EDTA, rosemary, cinnemaldehyde, allicin and eugenol.

This invention is also directed to a method for preventing fungal or protist infection in plants, plant tissues and seeds comprising contacting said plants, tissues and seeds with an effective amount of a fungicidal composition comprising polylysine, wherein the polylysine in said amount is effective to prevent said fungal or protist infection. The fungicidal composition may further comprise an effective amount of a compound selected from the group consisting of lysozyme, ovotransferrin, chicken immunoglobulins, chitosan, polylysine, protamine, nisin, EDTA, rosemary, cinnemaldehyde, allicin and eugenol.

### BRIEF DESCRIPTION OF THE DRAWINGS

FIG. 1 is a graph showing the lysozyme inhibition of IM095 Fusarium (Turfgrass isolate).

FIG. 2 is a graph showing the lysozyme inhibition of IM094 Curvularia (Poa).

FIG. 3 is a graph showing the efficacy of lysozyme in suppressing S. homoeocarpa on young bentgrass. Disease rating was based on a 1-10 visual scale where 1=≦10% infection, and 10=100% infection. Same shaded columns with the same letter indicate no significant difference (p≦0.01) between treatments.

FIG. 4 is a graph showing the efficacy of lysozyme in protecting mature bentgrass from S. homoeocarpa. Disease rating was based on a 1-10 visual scale where 1=≦10% infection, and 10=100% infection. Same shaded columns with the same letter indicate no significant difference (p≦0.01) between treatments.

FIG. 5 is a graph showing the inhibition of Sclerotinia homoeocarpa by lysozyme and chitosan (1000 ppm).

FIG. 6 is a graph showing the inhibition of Sclerotinia homoeocarpa by lysozyme and chitosan (2000 ppm).

FIG. 7 is a graph showing the inhibition of Sclerotinia homoeocarpa by lysozyme and polylysine(1000 ppm).

FIG. 8 is a graph showing the inhibition of Sclerotinia homoeocarpa by lysozyme and polylysine(2000ppm).

FIG. 9 is a graph showing the inhibition of Sclerotinia homoeocarpa by lysozyme and Lysozyme type 7 (1000 ppm).

FIG. 10 is a graph showing the inhibition of Sclerotinia homoeocarpa by lysozyme and Lysozyme type 7 (2000 ppm).

FIG. 11 is a graph showing the inhibition of IM193 (Pythium) by lysozyme.

FIG. 12 is a graph showing inhibition of IM194 (Phytophthora) by lysozyme.

FIG. 13 is a graph showing inhibition of IM195 (Pythium) by lysozyme.

FIG. 14 is a graph showing inhibition of IM080 (Botrytis) by lysozyme.

FIG. 15 is a graph showing inhibition of IM082 (Botrytis) by lysozyme.

FIG. 16 is a graph showing inhibition of IM111 (Botrytis) by lysozyme.

FIG. 17 is a graph showing inhibition of IM112 (Botrytis) by lysozyme.

FIG. 18 is a graph showing inhibition of IM113 (Botrytis) by lysozyme.

FIG. 19 is a graph showing inhibition of IM188 (Botrytis) by lysozyme.

FIG. 20 is a graph showing inhibition of IM114 (Monilinia) by lysozyme.

FIG. 21 is a graph showing inhibition of IM115 (Monilinia) by lysozyme.

### DETAILED DESCRIPTION OF THE INVENTION

When discussing such methods, the following terms have the following meanings unless otherwise indicated. Any undefined terms have their art recognized meanings.

The fungicidal composition contains 1 or more “active ingredients” or “fungicides” which is selected from the group avidin, lysozyme, ovotransferrin, chicken immunoglobulins, chitosan, polylysine, protamine, nisin, EDTA, rosemary, cinnemaldehyde, allicin and eugenol . The fungicide composition may additionally contain other components. Additionally, the fungicidal composition also prevents, inhibits or eradicates infection by protists, such as Pythium spp and Phytophthora spp.

“Avidin” is any enzyme capable of binding biotin with high affinity. Preferably, avidin is the basic egg white tetrameric glycoprotein made up of four identical polypeptide subunits. The amino acid sequence of an avidin subunit contains approximately 128-129 amino acids. Active avidin has a specific affinity for and binds with four molecules of biotin, one per subunit.

It is contemplated that the avidin may be naturally occurring avidin purified from eggs, it may be obtained from prokaryotic or eucaryotic cells modified to produce avidin or it may be produced synthetically. Avidin is commercially available from Canadian Inovatech, Inc., Abbotsford, B.C. Canada.

Without being limited to a theory, it is believed that avidin inhibits microbial growth by preventing uptake of biotin (Korpela et al., 1981⁶, Green 1975⁵).

Preferably, the activity of the avidin composition used in the fungicidal compositions of this invention has an activity of about 0.5 unit/mg to about 16 units/mg, and more preferably from about 5 units/mg to about 15 units/mg. One unit of avidin is defined as the amount of protein that will bind one microgram of d-biotin at pH 8.9 (Green 1963¹³).

“Lysozyme” used in the present invention is any lysozyme capable of degrading bacterial and yeast cell walls. Lysozymes (muramidase: mucopeptide N-acetylmucamoylhydrolase; 1,4-β-N acetylhexosaminodase, E.C. 3.2.1.17) are mucolytic enzymes which have been isolated from various sources and are well characterized. There are three classes of lysozymes, type c (chicken), type g(goose) and type v (viral).

Preferably, the lysozyme is type c egg white lysozyme. Egg white lysozyme is an enzyme that consists of approximately 129 amino acids, cross-linked by 4 disulfide bridges (Jolles and Jolles 1984³). Its molecular weight is approximately 14,300 to 14,600 daltons. The isoelectric point is pH 10.5-10.7. This polypeptide has muramidase and chitinase activity.

It is contemplated that the lysozyme may be naturally occurring lysozyme purified from eggs, it may be obtained from prokaryotic or eucaryotic cells modified to produce lysozyme or it may be produced synthetically. Lysozyme is commercially available from Canadian Inovatech, Inc., Abbotsford, B.C. Canada.

Preferably, the lysozyme composition used in the fungicidal compositions of this invention has an activity of about 10,000 units/mg to about 30,000 units/mg, more preferably from about 15,000 units/mg to about 24,000 units/mg. There are a number of methods for determining the activity of lysozyme (Shugar, D. 1952¹¹) One method for determining the activity of a lysozyme solution is to determine the change in absorbance of a Micrococcus lysodeikticus culture after the addition of the lysozyme solution. As the lysozyme lyses the Micrococcus cell wall, the absorbance of the culture decreases with time. One unit of lysozyme is the amount of enzyme that causes a decrease in absorbance of 0.001/min at 450 nm at pH 6.2 at 25° C.

“Ovotransferrin” means any protein capable of acting like egg white ovotransferrin. Egg white ovotransferrin, also known as conalbumin, is a glucoprotein with a molecular weight of approximately 78,000 daltons. It has an isoelectric point of 6.1. It contains two lobes connected by an α-helix. Each lobe is homologous and can bind an Fe³⁺ ion. The iron-binding site in each lobe is situated between two sub-domains. The presence of bicarbonate ion may enhance the binding of iron to the molecule.

“Polylysine” means a protein having a structural formula as shown below, in which units of L-lysine as an essential amino acid link together straightly:

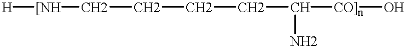

“Protamine” means a basic protein with high arginine content, usually found in association with DNA of spermatozoan nuclei of fish, birds, mammals, etc. (Johansen et al, 1995; Matsudomi et al, 1994; Uyttendaele and Debevere, 1994). The pI is 10-11.

“Chitosan” means a polymer composed of glucosamine residues linked by β, 1-4 glucosidic bonds (Wang, 1992). It is a deacetylated derivative of chitin, which is the structural polymer of the exoskeleton of shellfish.

“Nisin” means an antibacterial polypeptide produced by Lactococcus lactis subspecies lactis. with a molecular weight of 3,510 Daltons (Padgett et al, 1998).

“Allicin” mean an antimicrobial agent produced by plants of the Allium species, namely garlic and onion. The major antimicrobial constituent of garlic and onion has been identified as allicin or diallythiosulfinic acid along with several other sulfur-containing compounds. It has been reported that the extracts from Allium bulbs inhibit the growth and inspiration of pathogenic fungi and bacteria (Barone and Tansey, 1977; Willis, 1956).

“Rosemary” refers to the rosemary spice, which has been reported to have antimicrobial functionality. Shelef et al (1980) observed the inhibition of 20 food borne gram-positive organisms at 0.3% in the culture media and bactericidal effect at a level of 0.5%. The inhibitory effect was attributed to its terpene fraction which was comprised of borneol, cineole, pinene, camphene and camphor (Farrell, 1985).

“Cinnamaldehyde” refers to the compound cinnamaldehyde which can be extracted from cinnamon.

“Eugenol” refers to 2-methoxy-4[2-propenyl]phenol. This compound can be extracts from cloves and is commercially available from Sigma-Aldrich Canada Ltd. (Oakville, Ontario, Canada)

The term “effective amount” means that amount of an fungicidal composition which is capable of inhibiting the growth of the fungi or eradicating the fungi. This amount will be determined by those skilled in the art based on the amount of plant material to be treated, the time of treatment, and the activity of the fungicide to be used.

The terms “contact”, “contacting”, “application” or “applying” means the application of the antifungal composition to the plants, plant tissues and seeds by standard methods.

The fungicidal composition of the present invention may be a solid in the form of a cake, powder or granulates. Alternatively, the fungicidal composition may be a liquid, gel or paste. The fungicidal composition may be encapsulated in a micelle or liposome. It may be freeze dried or spray dried. The fungicidal composition may be a solution.

The fungicidal compositions of the present invention may comprise an effective amount of avidin. Where the fungicidal composition comprises an effective amount of avidin, preferably the concentration of avidin in the fungicidal composition is from 5% to about 100% by weight of the fungicidal composition, more preferably the concentration is from about 10% to 90% by weight and most preferably the concentration is from about 20% to 80% by weight.

Where the fungicidal composition of the present invention comprises an effective amount of lysozyme, preferably the concentration of lysozyme in the fungicidal composition is from 5% to about 100% by weight of the fungicidal composition, more preferably the concentration is from about 10% to 80% by weight and most preferably the concentration is from about 20% to 80% by weight.

A preferred fungicidal composition is a combination of an effective amount of avidin and an effective amount of lysozyme. Preferably, this composition comprises from about 5% to about 90% of avidin and from about 10% to about 95% lysozyme by weight. More preferably, this composition comprises from about 10% to about 80% avidin and from about 20% to about 90% lysozyme by weight.

The fungicidal compositions of this invention may further comprise from about 2% to about 25% of ovotransferrin, more preferably from about 5% to about 15% by weight.

One fungicidal composition useful in this invention is Lysozyme-type 7, (commercially available from Canadian Inovatech, Inc., Abbotsford B.C. Canada) which comprises approximately 10-25% lysozyme, 35-50% avidin, 20-35% ovalbumin, 5-20% ovotransferrin and other egg white proteins.

“Fungi” means any fungi whose growth is inhibited by exposure to the fungicidal composition. Examples of such fungi include, but are not limited to, the following: Aschochyta spp., Bipolaris sorokiniana, Botrytis cinerea, Botrytis spp., Candida spp., Colletotrichum graminicola, Coprinius psychoromorbidus, Curvularia spp., Didymella bryoniae, Drechslera siccans, Entolomya dactylidis, Fusarium nivale f sp., Fusarium spp., Gaeumannomyces graminis var. Avenae, Gaeumannomyces spp., Gloeosporium fructigenum, Kloeckera spp., Laetisaria fuciformis, Laetisaria spp., Leptosphaeria korrae, Magnaporthe poae, Monilinia spp., Pythium spp., Phytophthora spp., Pichia species, Pseudomonas spp., Rhizoctonia cerialis, Rhizoctonia solani, Rhizoctonia spp., Sclerotinia spp., Thanatephorus cucumeris, Thielaviopsis basicol.

One skilled in the art could determine which fungi are susceptible to a fungicidal composition comprising avidin, lysozyme, chitosan, protamine, polylysine and/or ovotransferrin by contacting the fungi with the fungicidal composition and measuring the inhibition of growth of the fungi.

The term “inhibition of growth” means that the number of viable cells of the fungi is reduced by at least 30%, more preferably by at least 40% and most preferably by at least 50%. The percentage of inhibition of growth can be determined by a number of ways known in the art. Such methods include cell counting under a microscope using a hemacytometer after staining for viable cells and culture plate assays or measuring the growth the fungal colony.

As used herein “plants” include both monocots and discots, particularly crop plants and ornamental plants. Representative dicots include, but are not limited to, potatoes, tobacco, tomatoes, carrots, apples, sunflowers, petunias and violets. Representative monocots include, but are not limited to, rice, rye corn, barley, wheat, other grasses, lilies, orchids and palms. Examples of suitable agricultural products, include but are not limited to, apples, apricots, asparagus, barley, beans, blueberries, bok choy, broccoli, bulbs, carrots, celery, cherries, cotton, cranberries, cucumbers, eggplant, flour, fruit juice, ginseng, peony, ginko, grains, grapes, hemp, hops and their products, kiwi fruit, lettuce, mushrooms, oranges, peaches, pears, peas, peppers, plums, potatoes, radishes, raspberries, rhubarb, sprouts, strawberries, tomatoes, tubors, wheat.

In particular, fungicidal composition is particularly useful when applied to a turfgrass “system”. The types of turfgrass plants which may be treated by the methods of this invention include, but are not limited to, Agrostis canina, Agrostis palustris, Agrostis tenuis, Cynodon dactylon, Festuca arundiinacea, Festuca arundinacea, Festuca rubra, Lolium multifflorum, Lolium perenne, Poa annua, Poa pratensis, Senotaphrum secundatum, and Zoysia japonica.

In particular the fungicidal composition is also useful when applied to grain prior to the malting process in beer making. Such process requires germination of the barley grains. Additionally, the fungicidal composition is also useful when applied to cut flowers, such as roses, to extend their shelf life or blooming time.

The fungicidal compositions of this invention will typically contain additional components which are compatible with plants, plant tissues and seeds. Such components may include, for example, buffer materials for pH control and the like.

The fungicidal composition of this invention may contain a compatible dispersing agent, emulsifying agent or wetting agent. Suitable surface-active agents include, but are not limited to, anionic compounds, such as a carboxylate, for example a metal carboxylate or a long chain fatty acid; an N-acylsarcosinate; mono and di-esters of phosphoric acid with fatty alcohol sulphates such as sodium dodecyl sulphate, sodium octadecyl sulphate; ethoxylated alkylphenol sulphates; lignin sulphonates; petroleum sulphonates; alkyl-aryl sulphonates such as alkyl-benzene sulponates or lower alkyl naphthalene sulphonates, salts of sulphonated naphthalene-formaldehyde condensates, salts of sulphonated phenol-formaldehyde condensates, or more complex sulphonates such as the amide sulphonates or the dialkyl sulphonates. Nonionic agents include condensation products of fatty acid esters, fatty alcohols, fatty acid amides or fatty-alkyl or alkenyl-substituted phenols with ethylene oxide, fatty esters and condensation products of such esters.

Examples of a cationic surface-active agent include, for instance, an aliphatic mono-,di- or polyamine as an acetate, naphtherate or oleate; an oxygen-containing amine such as an amine oxide or polyoxyethylene alkyamine, an amide-linked amine prepared by the condensation of a carboxylic acid with a di- or polyamine; or a quarternary ammonium salt.

A buffer may be included in the fungicidal composition in view of the fact that the fungicide enzymes are pH sensitive and thus, are desirably protected from potentially damaging variations in pH. When a buffer is employed, there may be used any buffer solution which is compatible with the avidin and/or lysozyme and which does not otherwise deleteriously affect the agricultural product. Preferably, the buffer is a material which is known to be safely used with a foodstuff.

It is contemplated that the fungicidal composition may additionally contain chemical or synthetic non-enzymatic antimicrobial compositions known in the art such as chlorophalonil and copper oxychloride. Such antimicrobial compositions must be compatible with the fungicide enzyme activity.

Water will often be used as a carrier for the avidin and lysozyme composition, but other conventional carriers may also be used.

Other additives may include preservatives such as potassium sorbate.

### Methodology

The fungicidal compositions can take any form known in the art for the formulation of agrochemicals, for example, a solution, a dispersion, an aqueous emulsion, a dusting powder, a seed dressing, a dispersible powder, an emulsifiable concentrate or granules. Moreover, it can be in a suitable form for direct application as a concentrate or primary composition which requires dilution with a suitable quantity of water or other diluent before application.

In this application, fungicide may be carried in a liquid suspension and dispensed as a spray. The concentration of fungicide could vary greatly and could conceivably be as small as 1 part per billion up to as high as 1 part, 500 parts or 100,000 parts per million on a weight/volume basis. Within that broad range, certain more specific ranges would be more effective. For example, the various ratios of concentrations could be as follows: 1 part/100,000,000; 1 part/10,000,000; 1 part/1,000,000; 1 part/500,000; 1 part/100,000; 1 part/50,000; 1 part/1,000; 1 part/500; 1 part/100; 1 part/50; 1 part/10.

The concentration of the granulated powder to be applied could be one part per billion all the way up to one part, 500 parts or 100,000 parts per million. Also, the numerical ratios and ranges given above relative to the spray could also apply.

Powdered fungicide could be incorporated as a coating or added into the fungicidal composition and dispersed throughout. The dispersed powder could also be encapsulated for delayed release in the product.

These granulated applications could be incorporated in a time release vehicle at the above concentrations to be applied to the plants. For example, if the time releases take place over a longer period of time, then quite possibly the concentrations could be varied accordingly.

Also, the size of the granulate of fungicide could vary between one tenth of a meter down to one ten millionth of a meter in diameter.

The fungicidal composition can be applied directly to the plant by, for example, spraying or dusting either at the time when the fungus has begun to appear on the plant, or before the appearance of the fungus as a protective measure. In both cases the preferred mode of application is by spraying.

Sometimes, it is practical to treat the roots of a plant before or during planting, for example, by dipping the roots in a suitable liquid or solid composition. The plants could be dipped into the fungicidal composition where the concentrations could be in the ranges given above. The dip could be a full or partial submersion of the agricultural product into a liquid suspension of the fungicidal composition.

Also the duration of dip treatment could vary greatly depending upon the concentration, granular size, type of fungi being treated, and other factors. The duration could be anywhere from 1 second to 1 year, and suggested ranges of time periods are: 1 second; 10 seconds; 30 seconds; 1 minute; 10 minutes; 30 minutes; 1 hour; 6 hours; 24 hours; one week; one month; 6 months and one year. Also, these could be in ranges of duration between any of these duration periods.

The fungicidal composition can also be applied to the seeds of the plants.

To prevent fungal contamination during the malting process of barley, rye or other grains contaminated with Fusarium during beer production the barley, rye or seed grains may be sprayed or dipped in the fungicidal composition prior to malting. Alternatively, the fungicidal composition may be sprayed on the malt during the malting process by spraying powder onto the wet barley grain.

Normally, the compositions are added to the agricultural product at room temperature. It is understood that the temperature of treatment should be compatible with production of the agricultural product. Preferably, the temperature range for treatment will be between 5° C. and 50° C. and more preferably between 10° C. and 40° C.

### Utility

The fungicidal compositions and method of this invention are useful in the inhibition of growth of certain pathogenic fungi on plants, plant tissues and seeds.

The following examples are offered to illustrate this invention, and are not to be construed in any way as limiting the scope of this invention. Unless otherwise stated, all temperatures are in degrees Celsius.

### EXAMPLES

In the examples below, the following abbreviations have the following meanings. If an abbreviation is not defined it has its generally accepted meaning.

g=grams

mg=milligram

μg=microgram

L=liter

ml=milliliter

μl=microliter

μm=micron

MIC=minimal inhibitory concentration

ppm=parts per million

rpm=revolutions per minute

### Example 1

### Evaluating the Efficacy of Lysozyme in Suppressing Fungal Diseases of Young Bentgrass

Fungal cultures isolated from turfgrass were collected from different sources including B.C. Ministry of Agriculture, Fisheries and Food and ATCC.

⅕ potato dextrose broth was prepared and autoclaved in Erlenmeyer flasks and allowed to cool. Different amounts of egg white lysozyme (Canadian Inovatech, Inc., B.C.) was weighed out and added directly into the flasks. Ten milliliters of broth was dispensed into sterile petri dishes. Various concentrations of egg white lysozyme were used to determine the minimum effective treatment concentration.

A fungal square (“plug”) of each culture was cut and placed in/near the center of each plate. The petri dishes were then incubated at 22-25° C. During incubation, the petri dishes were evaluated individually by measuring the diameter of fungal growth.

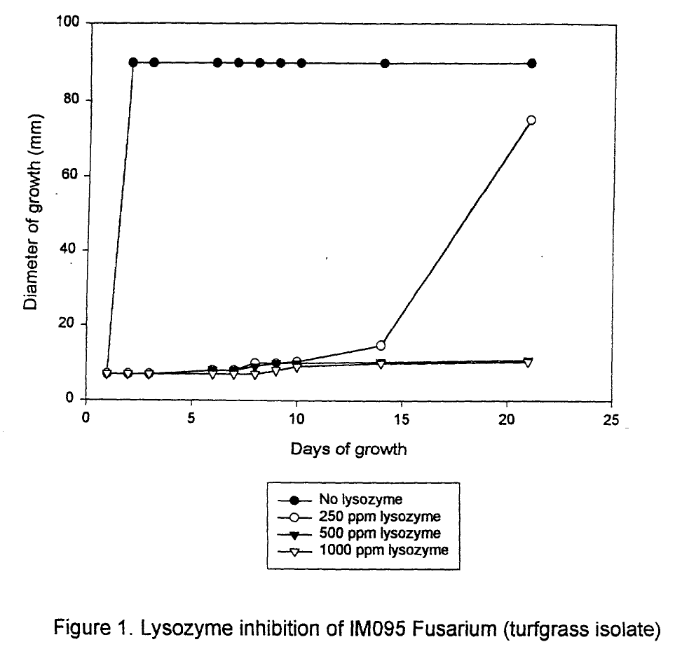

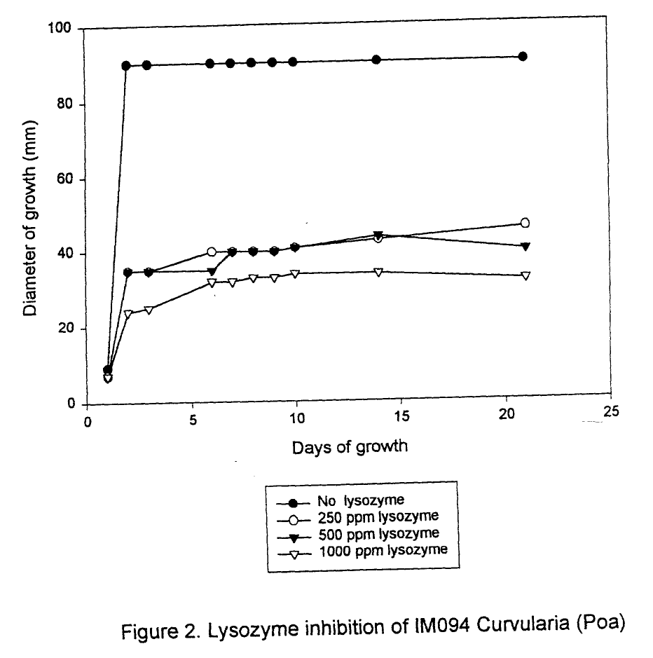

The in vitro trials indicated very good fungicidal or fungistatic activities against the tested pathogens. The results for the in vitro trials are presented in Table 1. FIGS. 1 and 2 show lysozyme inhibition against Fusarium and Curvularia (Poa), respectively.

TABLE 1
Minimum effective treatment
concentration of lysozyme against different fungi

| | | Lysozyme | Duration of trial | |
|---|---|---|---|---|
| Culture # | Fungi Name | (ppm) | (day) | Comment |
| IM079 | Rhizoctonia spp. | 150 | 38 | Excellent |
| | | | | inhibition |
| IM084 | Gaeumannomyces | 500 | 13 | Excellent |
| | graminis | | | inhibition |
| | var.avenae | | | |
| IM085 | Rhizoctonia | 250 | 13 | Fair-good |
| | solani | | | inhibition |
| IM086 | Typhula | 1000 | 21 | Excellent |
| | incarnata | | | inhibition |
| IM088 | Sclerotinia | 1000 | 21 | Fair-good |
| | homoeocarpa | | | inhibition |
| IM094 | Curvularia (Poa) | 1000 | 21 | Fair-good |
| | | | | inhibition |
| IM095 | Fusarium | 250 | 25 | Excellent |
| | | | | inhibition |
| IM099 | Gaeumannomyces | 1000 | 21 | Excellent |
| | graminis 97-923 | | | inhibition |
| IM100 | Gaeumannomyces | 1000 | 21 | Excellent |
| | graminis 97-923 | | | inhibition |

### Example 2

### Evaluating the Efficacy of Lysozyme in Suppressing Fungal Diseases of Young Bentgrass

Creeping bentgrass (Agrotis spp.) cv. Penncross was used as the host in the greenhouse trials. This species is widely used in golf greens and is easily managed under greenhouse conditions. Bentgrass was seeded in 6 cm diameter and 5 cm height pots (made from PVC pipes) containing steam sterilized river washed sand. A seeding rate of 0.1 g/pot was used to ensure rapid establishment of a uniform, dense stand. Throughout the experiment, the grass was regularly watered, fertilized and maintained at a cutting height approximately 2.0 cm above the soil surface.

Virulent isolates of test fungi were grown on a rye grain medium for approximately one week. This medium consisted of 50 g of rye grain, 1 g of CaCO₃, and 75 ml of water. It was prepared in a 250 ml Erlenmeyer flask and autoclaved for 30 minutes. Three to five plugs of the actively growing mycelia from week old cultures on potato dextrose agar were transferred into flasks, and incubated in the dark at room temperature.

Pots of eight-week-old bentgrass were inoculated with the test fungi by placing 2-3 kernels of infected rye in the center of the grass area, just above the soil surface. After inoculation, pots were placed in humidity chambers on a greenhouse bench. Temperature during incubation was maintained at 27-30° C. for disease development and the growth of the test fungi.

Egg white lysozyme was applied with a hand held spray bottle on bentgrass 24 hours after inoculation at concentrations of 0, 2,500, 5,000 and 10,000 ppm. Approximately 1.6-2.4 ml was applied to each pot and the treatment was repeated 24 hours later. Untreated bentgrass was used as a control. All treatments were replicated 8 times and arranged in a completely randomized design. This trial was repeated three times.

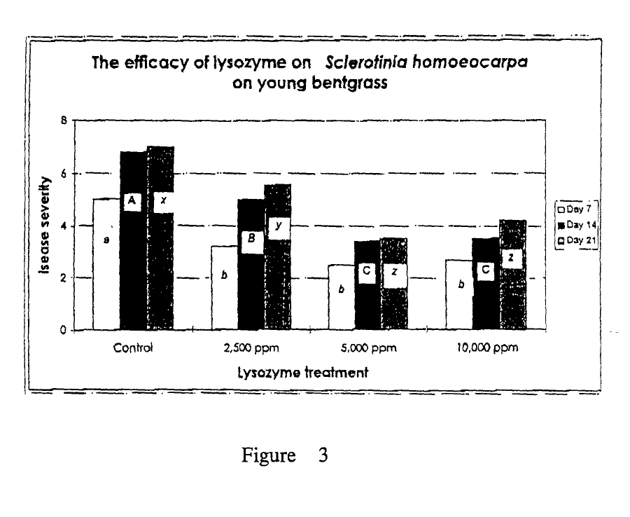

The results from the in vivo trials show that egg white lysozyme is very effective in suppressing the infection of bentgrass pathogens. For example, significant S. homoeocarpa inhibition was apparent on bentgrass treated with 2,500, 5,000, and 10,000 ppm of lysozyme on day 7, 14 and 21 after inoculation when compared to the untreated control (FIG. 3). Bentgrass treated with 5,000 and 10,000 ppm of lysozyme had significantly less infection on day 14 and 21 after inoculation when compared with bentgrass treated with 2,500 ppm of lysozyme.

Lysozyme treatments at 5,000 and 10,000 ppm also provided good control against M. nivale and G. graminis. These two concentrations displayed no signs of phytotoxicity on bentgrass for the duration of the trial.

### Example 3

### Evaluating the Protective or Suppressive Effect of Lysozyme on Fungal Diseases of Mature Bentgrass

One year old bentgrass (Agrotis spp.) cv Pennlink was used as the host in this trial. It was grown in an open field at Select Sand Farm in Fort Langley, B.C. Round pieces of turfgrass, 6 cm diameter, were cut out and placed on 5 cm high pots (made from PVC pipes) containing steam sterilized river washed sand. The potted grass was regularly watered, fertilized and maintained at a cutting height of approximately 2.0 cm above the soil surface.

The efficacy of egg white lysozyme was tested on Sclerotinia homoeocarpa. Virulent isolates of the test fungi were grown on a rye grain medium for approximately one week. This medium consisted of 50 g of rye grain, 1 g of CaCO₃, and 75 ml of water. The medium was prepared in a 250 ml Erlenmeyer flask and autoclaved for 30 minutes. Three to five plugs of the actively growing mycelia from one-week-old culture on potato dextrose agar were transferred into flasks, and incubated in the dark at room temperature.

In a first test, three weeks after they were potted, bentgrass was treated with approximately 2.4 ml of egg white lysozyme solution at concentrations of 0, 5,000, 10,000, or 20,000 ppm 24 hours before fungal inoculation. Lysozyme was applied with a hand held spray bottle. Treated and untreated bentgrass was then inoculated with the test fungi by placing 3 infected rye kernels in the center of the pot, just above the soil surface. After inoculation, the pots were placed in humidity chambers on a greenhouse bench. Temperature during incubation was maintained at 27-30° C. for disease development and the growth of the test pathogens.

In a second test three weeks after it was potted, the bentgrass was first inoculated with the test fungi by placing 3 infected rye kernels in the center of the pot, just above the soil surface. After inoculation, the pots were placed in humidity chambers on a greenhouse bench. Temperature during incubation was maintained at 27-30° C. for disease development. Approximately 2.4 ml of egg white lysozyme solution at concentrations of 0; 5,000; 10,000 or 20,000 ppm was applied with a hand held spray bottle on bentgrass 24 and 48 hours after inoculation.

All treatments were replicated 8 times and arranged in a completely randomized design. This trial was repeated once.

Pots were removed from the humidity chamber and evaluated individually for disease severity. A 1-10 visual rating scale was used which corresponds to the percentage of infection, where 1=≦10% infection, 5=≦50% infection, 10=100% infection. Data obtained from disease severity was subjected to analysis of variance and multiple comparison (Student—Newman—Keul's test) with an SAS package.

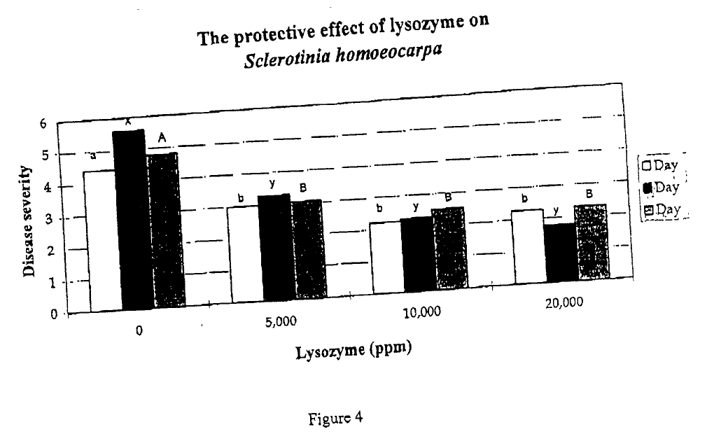

Egg white lysozyme was effective in protecting mature bentgrass from S. homoeocarpa (FIG. 4). There were significant reductions (p≦0.01) in disease severity on bentgrass treated with 5,000, 10,000, or 20,000 ppm of lysozyme when evaluated on day 7, 10 or 21 after inoculation compared to the untreated control. There were no significant differences among the three lysozyme concentrations. However, when lysozyme was tested as a suppressive treatment, the enzyme was not effective at reducing the infection of S. homoeocarpa when evaluated on day 7, 14 or 21 after inoculation except for bentgrass treated with 5,000 ppm of lysozyme on day 21.

Results of the in vitro and in vivo trials clearly demonstrated that lysozyme possesses good levels of fungicidal or fungistatic properties against selected fungi. Lysozyme was most effective against S. homoeocarpa, as a suppressive treatment on young bentgrass in the in vivo Trial 1 and a protective treatment on mature bentgrass in Trial 2.

Higher concentrations of egg white lysozyme may not be necessary to reduce the spread of infection. In both in vivo trials, 5,000 to 10,000 ppm of lysozyme were sufficient in limiting the growth of S. homoeocarpa on bentgrass for up to 21 days.

### Example 4

### Pytotoxicity Evaluation

Egg white lysozyme was tested for phytotoxicity at all the test concentrations on bentgrass. Potted, mature bentgrass was treated with approximately 2.4 ml of lysozyme at 0, 5,000, 10,000 or 20,000 ppm, and this was repeated 24 hours later. Treated bentgrass was placed under the same conditions as the inoculated bentgrass and was evaluated for signs of phytotoxicity i.e. stunning, thinning, discoloration, or chemical burn on day 7, 14 and 21 after treatment.

No sign of phytotoxicity was observed on matured bentgrass treated twice with up to 20,000 ppm lysozyme. However, some white residues were found on the bentgrass treated with 20,000 ppm of lysozyme. The presence of the solidified lysozyme did not cause any damage to the bentgrass or reduce its growth.

### Example 5

### Inhibition of Sclerotinia homoeocaipa by lysozyme, chitosan, polylysine and avidin

Potato dextrose broth was prepared. Fifty ml of the PD broth was added into 100 ml dilution bottles, autoclaved and cooled to room temperature. Various amounts of lysozyme, chitosan, polylysine and avidin were weighed into the bottles. Ten ml of the PD broth with or without the antimicrobials was transferred into sterile petri dishes. A plug of Sclerotinia homoeocarpa (about 6-10 mm square) grown on PD agar was placed into the center of each petri dish. Table 2 is a summary of the treatments. These treatments were all done in triplicates. Fungal growth was monitored by measuring the area of the growth.

TABLE 2
Treatments for the inhibition of Sclerotinia homoeocarpa by lysozyme,
chitosan, polylysine and avidin

| | Antimicrobial and Concentration | |
|---|---|---|
| Treatment | (ppm) | Total concentration |
| 1 | Lysozyme | 1000 |
| 2 | Lysozyme | 2000 |
| 3 | Chitosan | 1000 |
| 4 | Chitosan | 2000 |
| 5 | Polylysine | 1000 |
| 6 | Polylysine | 2000 |
| 7 | Lysozyme-type 7 | 1000 |
| 8 | Lysozyme-type 7 | 2000 |
| 9 | Lysozyme:chitosan 1:1 | 1000 |
| 10 | Lysozyme:chitosan 1:1 | 2000 |
| 11 | Lysozyme:chitosan 1:2 | 1000 |
| 12 | Lysozyme:chitosan 1:2 | 2000 |
| 13 | Lysozyme:chitosan 1:3 | 1000 |
| 14 | Lysozyme:chitosan 1:3 | 2000 |
| 15 | Lysozyme:chitosan 2:1 | 1000 |
| 16 | Lysozyme:chitosan 2:1 | 2000 |
| 17 | Lysozyme:chitosan 3:1 | 1000 |
| 18 | Lysozyme:chitosan 3:1 | 2000 |
| 19 | Lysozyme:polylysine 1:1 | 1000 |
| 20 | Lysozyme:polylysine 1:1 | 2000 |
| 21 | Lysozyme:polylysine 2:1 | 1000 |
| 22 | Lysozyme:polylysine 2:1 | 2000 |
| 23 | Lysozyme:polylysine 4:1 | 1000 |
| 24 | Lysozyme:polylysine 4:1 | 2000 |
| 25 | Lysozyme:polylysine 6:1 | 1000 |
| 26 | Lysozyme:polylysine 6:1 | 2000 |
| 27 | Lysozyme:lysozyme type 7 1:1 | 1000 |
| 28 | Lysozyme:avidin 1:1 | 2000 |
| 29 | Lysozyme:avidin 1:2 | 1000 |
| 30 | Lysozyme:avidin 1:2 | 2000 |
| 31 | Lysozyme:avidin 1:3 | 1000 |
| 32 | Lysozyme:avidin 1:3 | 2000 |
| 33 | Lysozyme:avidin 2:1 | 1000 |
| 34 | Lysozyme:avidin 2:1 | 2000 |
| 35 | Lysozyme:avidin 3:1 | 1000 |
| 36 | Lysozyme:avidin 3:1 | 2000 |
| 37 | Control, no antimicrobial | 0 |

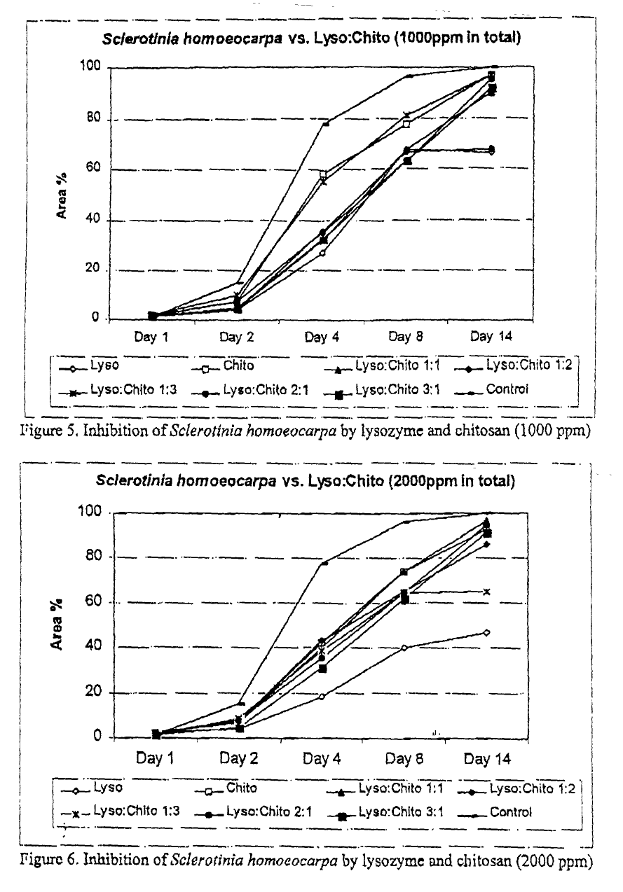

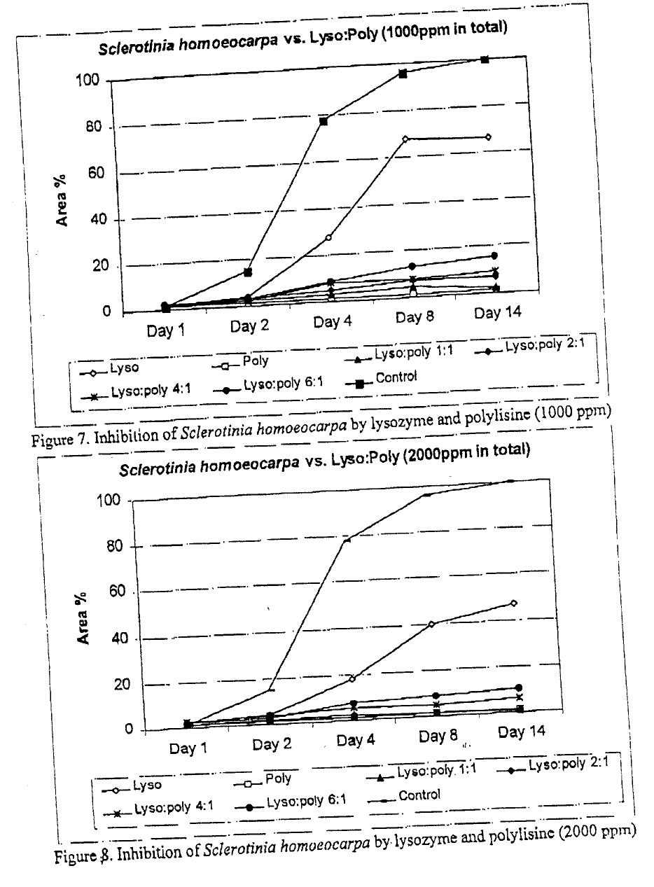

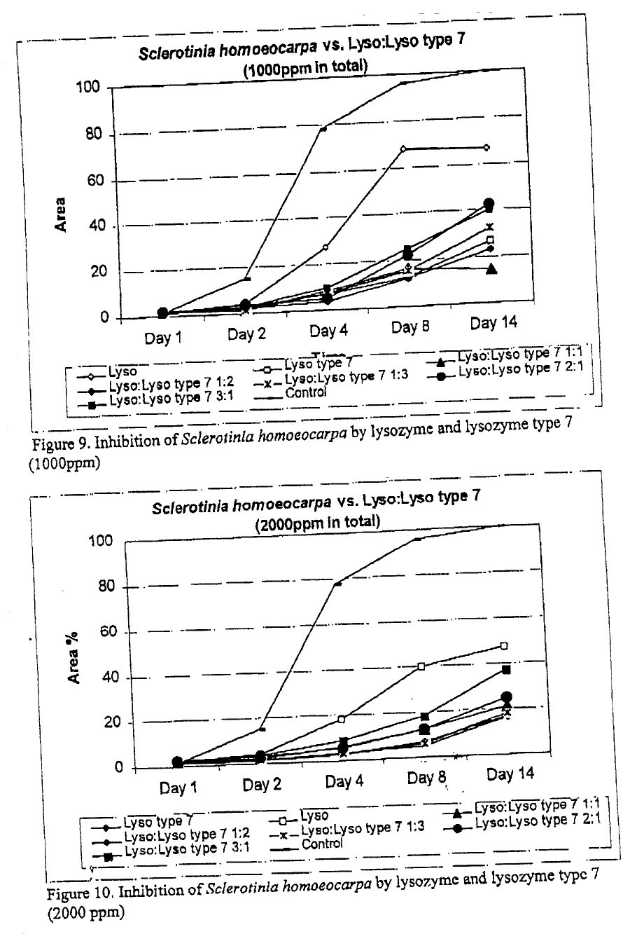

The results for the inhibition of Sclerotinia homoeocarpa are presented in FIGS. 5-10. It can be seen that 1000 ppm of lysozyme or the combination of lysozyme and chitosan (1:2 ) can reduce the fungal growth by 35% 2 weeks after the inoculation. 2000 ppm of lysozyme reduced the fungal growth by about 55% for the same period. At this concentration, lysozyme:chitosan at a ratio of 1 to 3 showed better inhibition results than the 1:2.

Both at 1000 ppm and 2000 ppm total antimicrobial, lysozyme and polylysine at any ratio showed much better inhibition of Sclerotinia homoeocarpa than lysozyme used alone.

In the case of lysozyme in combination with Lysozyme-type 7, at both 1000 and 2000 ppm total concentration, any ratio of combination showed better inhibition results than lysozyme alone. In general, Lysozyme-type 7 was more effective in controlling the fungal growth than lysozyme. No significant difference was found between 1000 and 2000 ppm total concentration when the combinations are used.

### Example 6

### Lysozyme against Fusarium in PD Agar

When beer is made from barley, rye or other grains contaminated with Fusarium, the toxins produced by the fungi can be carried through the malting and kilning process all the way to the final product. One particular toxic compound is deoxvnivalenol (DON), sometimes referred to as vomitoxin. Studies have shown that high doses of the toxins can be lethal to lab animals although the threat to humans from typically low levels that might be found in beer has yet to be clearly established. Some brewing companies have 0 tolerance in DON contamination in the malt. Accordingly, the inhibition of the Fusarium growth with lysozyme was tested.

PD broth was prepared and autoclaved in dilution bottles (100 ml) and allowed to cool. Required amounts of lysozyme were added into the bottles and dissolved. 10 ml of the broth from each lysozyme concentration was dispensed into sterile petri dishes. A square of Fusarium (5-10 mm square “plug”) was cut and placed in/near the center of each dish. The plates were incubated at room temperature for 2 weeks. The trial was carried out in triplicate and was repeated three times.

The fungal growth was quantified by measuring the diameter of Fusarium growth and the coverage of the plates by the fungus. The measurements (given in mm) also include the size of the inoculum plug inserted into the plate of media. The color change and the change in the physical appearance (fuzzy, not fuzzy) were also monitored. The Fusarium growth is pink to dark pink. The observations for the three trials and three batches are presented in Tables 3-5. All the numbers shown are the averages of three replicates for each treatment. The diameter of the plate was approximately 85 mm.

Lysozyme showed inhibition of Fusarium at various concentrations. At 250 ppm of lysozyme, Fusarium growth was quite limited, although the color of the broth turned yellow after 10 days. Lysozyme concentrations lower than 250 ppm also showed some inhibition, but it was not as effective.

TABLE 3
Lysozyme against Fusarium - Batch 1
Date

| | Nov. 26, | | | |
|---|---|---|---|---|
| | 1998 | Nov. 30, 1998 | Dec. 3, 1998 | Dec. 7, 1998 |
| Day | 0 | 4 | 7 | 11 |
| 0 ppm | 8.3 mm | Confluent, pink | Confluent, dark | Confluent, dark |
| control | | | pink | pink, fuzzy |
| 25 ppm | 9.3 mm | Confluent, pink | Confluent, dark | Confluent, dark |
| lysozyme | | | pink | pink, fuzzy |
| 50 ppm | 9.7 mm | Confluent, pink | Confluent, dark | Confluent, dark |
| lysozyme | | | pink | pink, fuzzy |
| 75 ppm | 8.3 mm | 23.7 mm | 27.0 mm | Confluent, dark |
| lysozyme | | 36.7% covered | 60% covered | pink, fuzzy |
| 100 ppm | 8.0 mm | 23.7 mm | 28.3 mm | Dark pink |
| lysozyme | | 26.7% covered | 46.7% covered | 80% covered |
| 250 ppm | 8.7 mm | 16.0 mm | 22.0 mm | Yellow broth |
| lysozyme | | | | 29.7% covered |

TABLE 4
Lysozyme against Fusarium - Batch 2.

| | Date | | | | | |
|---|---|---|---|---|---|---|
| | Dec. 3, | Dec. 7, | Dec. 9, | Dec. 11, | Dec. 14, | Dec. 17, |
| | 1998 | 1998 | 1998 | 1998 | 1998 | 1998 |
| Day | 0 | 4 | 6 | 8 | 11 | 14 |
| 0 ppm | 7.3 mm | 63.3% | 65% | 66.7% | 68.3% | 71.7% |
| control | | covered | covered | covered | covered | covered |
| | | pink | dark pink | dark pink, | dark pink, | dark pink, |
| | | | | fuzzy | fuzzy | fuzzy |
| 25 ppm | 7.8 mm | 76.7% | 88.3% | 91.7% | 91.7% | 91.7% |
| lysozyme | | covered | covered, | covered | covered | covered |
| | | dark peach | pink | dark pink | dark pink | dark pink, |
| | | | | | | fuzzy |
| 50 ppm | 7.5 mm | 43.3% | 60% | 61.7% | 68.3% | 55.0% |
| lysozyme | | covered | covered, | covered | covered | covered |
| | | peach | pink | dark pink | dark pink | dark pink, |
| | | | | | | fuzzy |
| 75 ppm | 8.0 mm | 21.3 mm | 40% | 46.7% | 61.7% | 68.3% |
| lysozyme | | 13.3% | covered | covered | covered | covered |
| | | covered | pink | pink | dark pink | dark pink, |
| | | peach | | | | fuzzy |
| 100 ppm | 7.8 mm | 22.3 mm | 20.0 mm | 30.3% | 37 mm | 42.7 mm |
| lysozyme | | peach | light peach | covered | pink/yellow | pink, fuzzy |
| | | | | pink | broth | |
| 250 ppm | 7.3 mm | 17.0 mm | 19.7 mm | 22 mm | 25.7 mm | 35.0 mm |
| lysozyme | | light peach | very light | dark peach | yellow broth | pink, fuzzy |
| | | | peach | | | |

TABLE 5
Lysozyme against Fusarium - Batch 3

| | Date | | | | |
|---|---|---|---|---|---|
| | Dec. 10, | | | Dec. 21, | |
| | 1998 | Dec. 14, 1998 | Dec. 17, 1998 | 1998 | Dec. 24, 1998 |
| Day | 0 | 4 | 7 | 11 | 14 |
| 0 ppm | 8.3 mm | 27.0 mm | 67.7% | 68.3% | 68.3% covered, |
| Control | | 40% covered, | covered, | covered, | dark pink, fuzzy |
| | | light peach | dark pink, | dark pink, | |
| | | | fuzzy | fuzzy | |
| 25 ppm | 8.2 mm | 26.3 mm | 24.7 mm | 31.3 mm | 32.0 mm |
| lysozyme | | 25% covered | 33.3% covered | 38.3% | 45.0% covered, |
| | | peach | pink, fuzzy | covered, | pink, fuzzy |
| | | | | pink, fuzzy | |
| 50 ppm | 7.5 mm | 22.7 mm | 25.7 mm | 28.0 mm | 29.3 mm |
| lysozyme | | 28.3% covered | 41.7% covered | 41.7% | 48.3% covered, |
| | | peach | pink, fuzzy | covered, | pink, fuzzy |
| | | | | pink, fuzzy | |
| 75 ppm | 8.2 mm | 25.2 mm | 32.7 mm | 41.0 mm | 43.7 mm |
| lysozyme | | peach | pink, fuzzy | pink, fuzzy | 38.1% covered, |
| | | | | | pink, fuzzy |
| 100 ppm | 8.7 mm | 21.7 mm | 25.0 mm | 26.0 mm | 26.7 mm |
| lysozyme | | peach | pink, fuzzy | pink, fuzzy | 34.9% covered, |
| | | | | | pink, fuzzy |
| 250 ppm | 7.3 mm | 12.2 mm | 20 mm | 29.7 mm | 38.7 mm |
| lysozyme | | yellow | peach, fuzzy | peach with | peach with yellow |
| | | | | yellow broth | broth |

### Example 7

### Lysozyme against Fusarium inoculated from liquid broth

PD broth was prepared and autoclaved in dilution bottles (100 ml) and allowed to cool. Various amounts of lysozyme were added into the bottles and dissolved. 10 ml of the broth from each lysozyme concentration was dispensed into sterile petri dishes. One ml of Fusarium broth was transferred into each dish and the contents were mixed well. The plates were incubated at room temperature for 2 weeks. The trial was carried out in triplicate and was repeated three times. Pictures of the fungi were taken daily using a digital camera and the data was transferred on to the computer and processed.

Similar to the previous trial, lysozyme showed very good inhibition against Fusarium at 250 ppm. Lysozyme can effectively inhibit Fusarium. Under the experimental conditions, 250 ppm of lysozyme can limit the growth of Fusarium for two weeks. At lysozyme concentrations of 100 ppm or lower, the inhibition was not very effective.

### Example 8

### Inhibition of Pythium and Phytophthora by lysozyme

Strains of Pythium can cause problems for various plants including potatoes, tomatoes, turfgrass etc. The diseases, crown blight or root rot, are favored during rainy, foggy weather and in low-lying areas where air circulation is poor. Pythium can also cause root rot in hydroponic systems.

Phytophthora is also one of the most serious plant pathogens in British Columbia and many parts of the world. It causes potato and tomato late blight, root rot and other problems for many crops.

Potato dextrose broth was prepared, poured into glass dilution bottles (100 ml each), autoclaved and allowed to cool. Various amounts of lysozyme were added into 6 broth treatments (Table 6). Ten ml of the broth from each lysozyme concentration was dispensed into petri dishes. A fungal square (plug) of each culture was cut and placed in/near the center of each plate. Fungal growth was quantified by measuring the diameter of growth of each fungus while it was growing on the liquid media in each petri dish using a ruler. Each treatment was done in triplicate.

The experiment was repeated three times (three batches). The observation period for each batch was 2 weeks.

TABLE 6
Experimental design for inhibition of Pythium and Phytophthora
by lysozyme

| | | Weight of lysozyme for |
|---|---|---|
| Treatment | Lysozyme concentration (ppm) | 100 ml broth (mg) |
| 1 | 0 | 0 |
| 2 | 50 | 5 |
| 3 | 100 | 10 |
| 4 | 250 | 25 |
| 5 | 500 | 50 |
| 6 | 1000 | 100 |

The fungal growth was expressed in % coverage of the petri dishes by the fungal patches. The calculation can be presented in the following equation:

Fungal growth (%)=(area of fungal patch/total plate area)×100

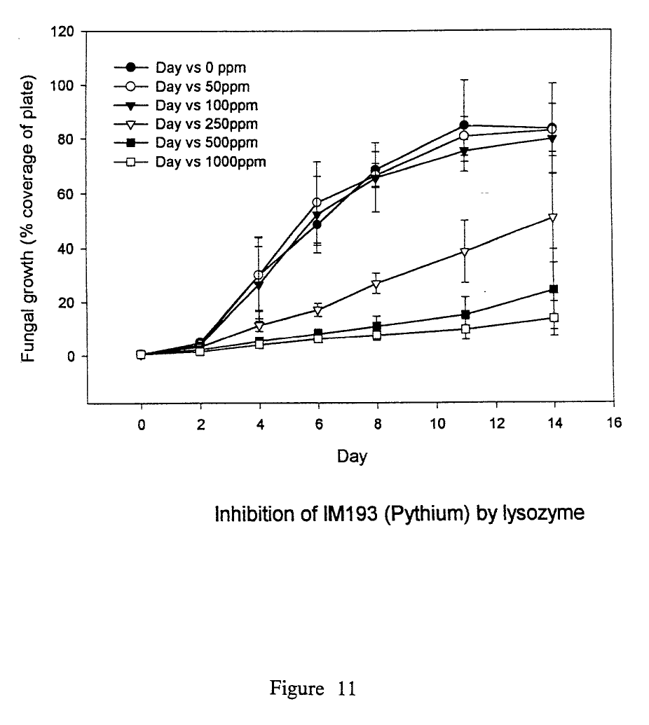

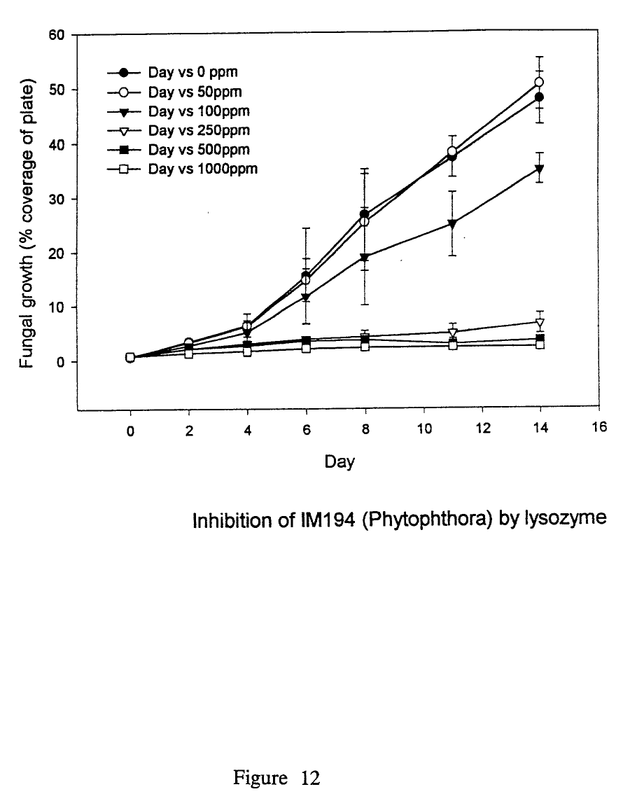

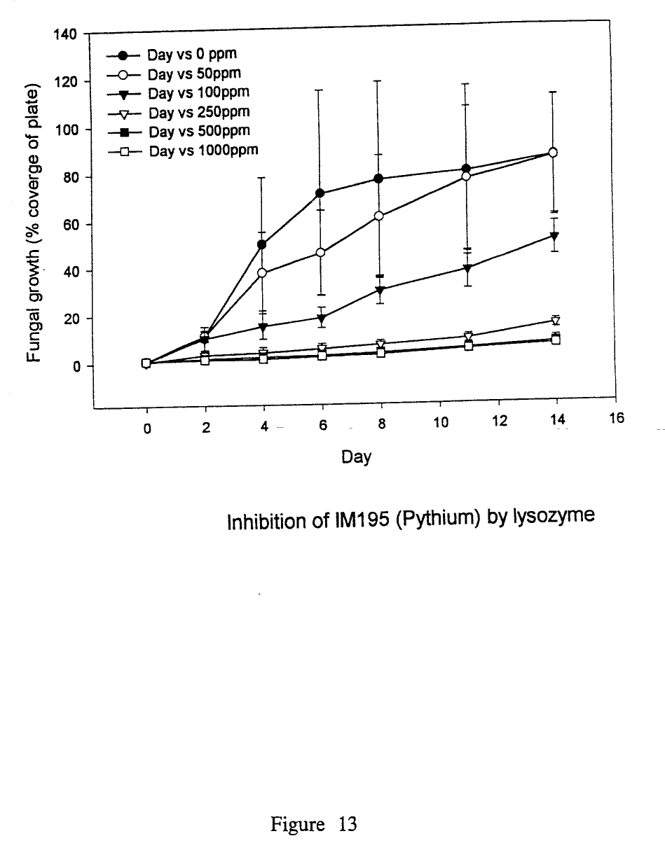

The average plate coverage of the 9 observations for each treatment was plotted in FIGS. 11-13. It can be seen that lysozyme was very effective in inhibiting the Pythium and Phytophthora strains tested.

For Pythium torrulesum (IM193), 80% of the plates were covered with the fungus at the end of the 2 weeks for lysozyme concentrations of 0, 50 and 100 ppm, However, the fungal coverage was reduced to 51%, 25% and 14% for lysozyme concentrations of 250, 500 and 1000 ppm, respectively. Two way ANOVA (analysis of variance) showed that there are significant fungal growth differences for the various concentrations of lysozyme (p<0.01). Multiple comparison (Tukey test) indicates fungal growth at 250, 500 or 1000 ppm of lysozyme was significantly lower than at 100, 50 or 0 ppm (p<0.05).

For Pythium sylvaticom (IM195), the fungal growth for 0, 50, 100, 250, 500 and 1000 ppm of lysozyme treatments was 86%, 86%, 51%, 15%, 7% and 6%, respectively. The inhibition at higher lysozyme concentration was even more effective. Two way ANOVA showed that there are significant fungal growth differences for different concentrations of lysozyme (p<0.01). Multiple comparison (Tukey test) indicates that fungal growth at 250, 500 or 1000 ppm of lysozyme was significantly lower than at 100, 50 or 0 ppm (p<0.05).

Phytophthora cinnamomi (IM194) did not grow as fast as the two Pythium strains for the control but the inhibition by lysozyme was obvious. The fungal growth 2 weeks after inoculation for the 6 lysozyme concentration was 48%, 50%, 35%, 7%, 4% and 2%, respectively. Two way ANOVA showed that there were significant growth differences for different concentrations of lysozyme (p<0.01). Multiple comparison (Tukey test) indicated fungal growth at 250, 500 or 1000 ppm of lysozyme was significantly lower than at 100, 50 or 0 ppm (p<0.05).

From the above results, it can be concluded that lysozyme is very effective in inhibiting Pythium and Phytophthora growth.

### Example 9

### Inhibition of Botrytis by lysozyme

Botrytis is one of the major problems for fruit rot diseases for raspberries, strawberries, blueberries, etc. It can be counted for 50% of the crop loss. The efficacy of lysozyme in inhibiting the growth of various strains of Botrytis was tested.

Botrytis was grown in petri dishes on PD agar. Potato dextrose broth was prepared, poured into glass dilution bottles (100 ml each), autoclaved and allowed to cool. Various amounts of lysozyme was added into the broth for 6 treatments (Table 7). Ten ml of the broth from each lysozyme concentration was dispensed into petri dishes. A fungal square (plug) of each culture was cut and placed in/near the center of each plate. Fungal growth was quantified by measuring the diameter of growth of each fungus while it was growing on the liquid media in each petri dish using a ruler. Each treatment was done in triplicate. The experiment was repeated three times (three batches). The observation period for each batch was 2 weeks.

TABLE 7
Treatments for inhibition of six strains of Botrytis by lysozyme

| | | Weight of lysozyme for |
|---|---|---|
| Treatment | Lysozyme concentration (ppm) | 100 ml broth (mg) |
| 1 | 0 | 0 |
| 2 | 50 | 5 |
| 3 | 100 | 10 |
| 4 | 250 | 25 |
| 5 | 500 | 50 |
| 6 | 1000 | 100 |

The fungal growth was expressed in % coverage of the petri dishes by the fungal patches. The calculation is presented in the following equation:

Fungal growth (%)=(area of fungal patch/total plate area )×100

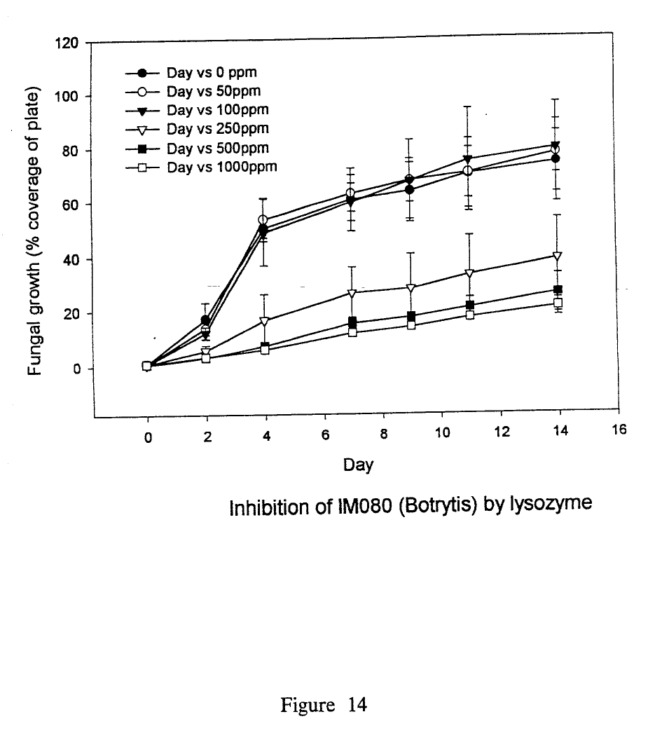

The average plate coverage for each treatment was plotted against the time after inoculation (FIGS. 14-19). Statistical analysis was carried out using SigmaStat (Version 2.0, SPSS Science, 1997). From FIGS. 14 to 19, it is clear that lysozyme can effectively inhibit the growth of the 6 Botrytis strains tested.

### IM080 Botrytis (pepper, BCMAF F24)

Two way ANOVA indicates that there was a significant difference among the treatments (p<0.01). Tukey multiple comparison shows that the fungal growth (% plate coverage) was significantly reduced when 250, 500 and 1000 ppm of lysozyme was applied compared to 0, 50 and 100 ppm. No significant difference in fungal growth was found among the 0, 50 and 100 ppm lysozyme treatments. 500 and 1000 ppm of lysozyme significantly reduced the fungal growth compared with 250 ppm lysozyme but no significantly difference was found between 500 and 1000 ppm lysozyme treatments.

On day 14, the average fungal growths for 0, 50, 100, 250, 500 and 1000 ppm lysozyme treatments were 74.3%, 77.7%, 79.5%, 38.6%, 25.7% and 20.8%, respectively (FIG. 14). Minimum lysozyme usage of 250-500 ppm is recommended.

### IM082 Botrytis (blueberry, BCMAF F25)

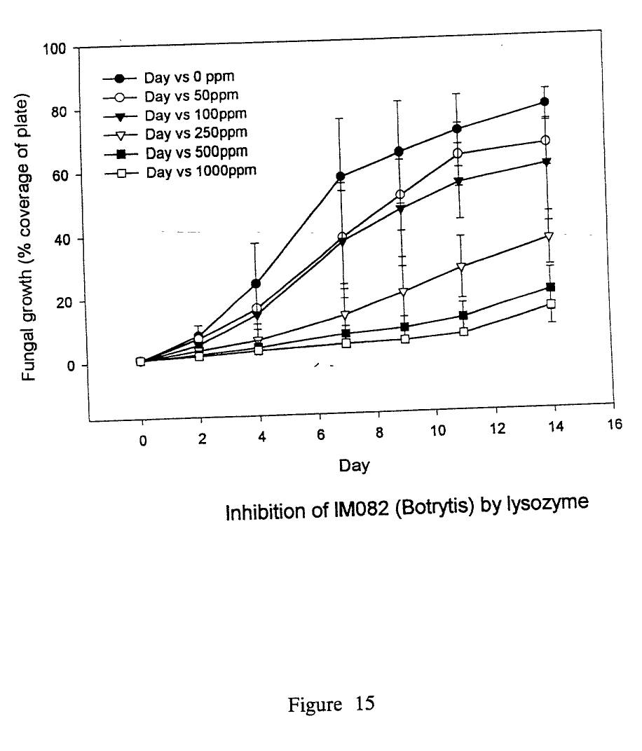

Two way ANOVA also showed significant differences among the different concentrations of lysozyme treatments. For this Botrytis strain, the effectiveness was more gradual. Even 50 ppm lysozyme significantly reduced the fungal growth (p<0.05). There was a significant growth difference between all the treatments except 50 vs. 100 ppm, 250 vs. 500 ppm and 500 vs. 1000 ppm. On day 14, the coverage of the petri dishes was 78.2%, 65.8%, 59.5%, 36.1%, 19.9% and 14.4% for 0, 50, 100, 250, 500 and 1000 ppm lysozyme, respectively (FIG. 15).

### IM111 Botrytis (blueberry, BCMAF F27)

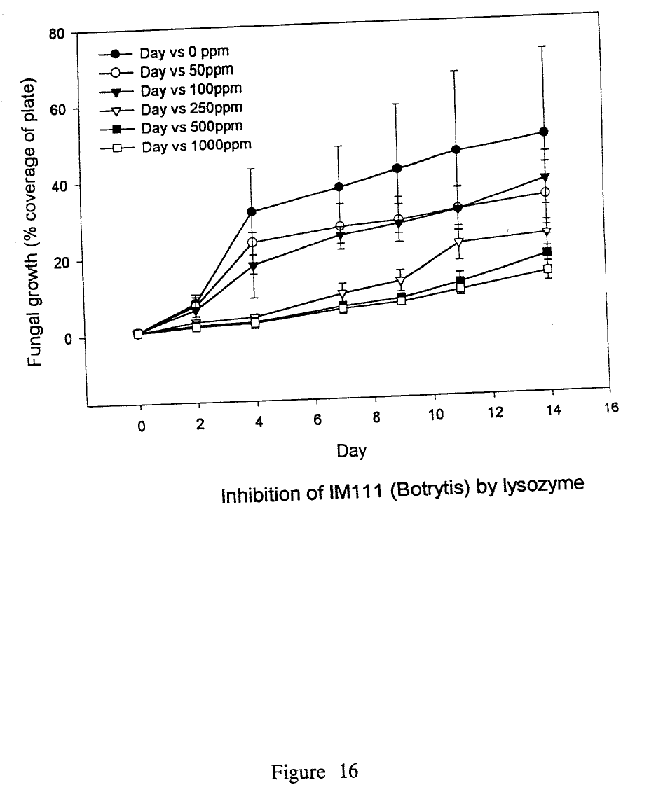

The inhibition of IM111 is presented in FIG. 16. Even 50 ppm lysozyme significantly reduced the fungal growth (p<0.05). No significant difference was found between 50 and 100 ppm or among 250, 500 and 1000 ppm. The fungal growths on day 14 were 49.2%, 33.7%, 37.8%, 23.5%, 18.0% and 13.6%, respectively.

### IM112 Botrytis cinerea(Pers.) (from grape litter, Summerland Research Station, Botrytis 12)

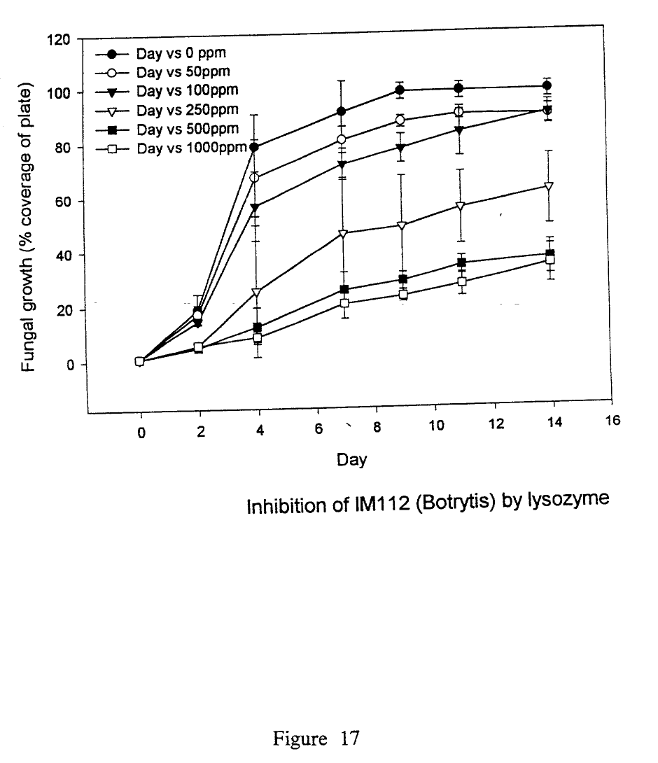

The inhibition of IM112 is presented in FIG. 17. No significant difference was found between the treatments with 0 and 50 ppm lysozyme. 100 ppm lysozyme is required to significantly reduce the growth of this Botrytis strain (p<0.05). There is no significant difference between the treatments with 50 and 100 ppm, and 500 and 1000 ppm lysozyme. The fungal growths for the treatments with 0, 50, 100, 250, 500 and 1000 ppm of lysozyme were 98.3%, 89.4%, 90.0%, 61.5%, 36.2% and 33.9%, respectively.

### IM113 Botrytis cinerea(Pers.) (from Winfield pink type apple, Summerland Research Station)

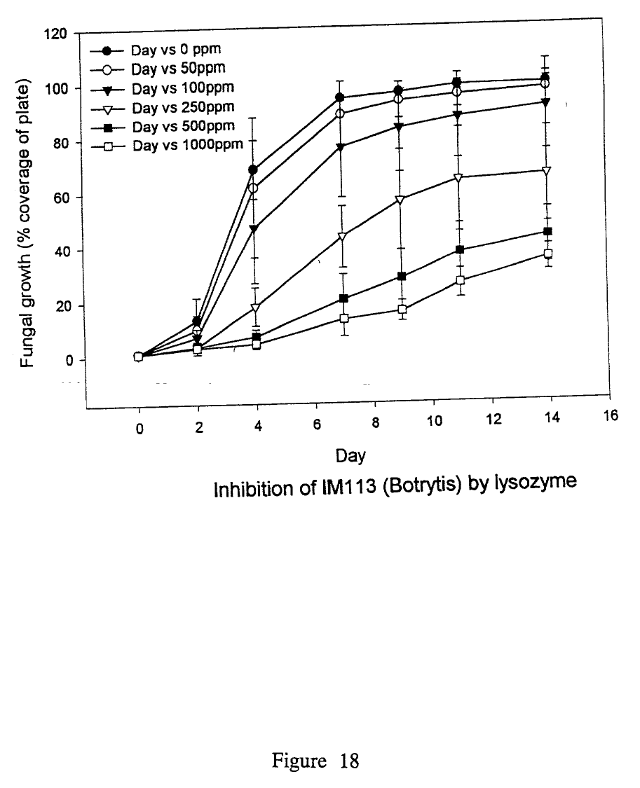

The inhibition of IM113 is presented in FIG. 18. The results are very similar to IM112. A minimum of 100 ppm of lysozyme is required to effectively inhibit this Botrytis strain (p<0.05). No significant difference was found between 50 and 100 ppm or 500 and 1000 ppm (p<0.05). The fungal growths on day 14 were 98.9%, 96.9%, 90.6%, 65.4%, 43.0% and 34.7% for the six treatments, 0, 50, 100, 250, 500 and 1000 ppm, respectively.

### IM188 Botrytis cinerea (from Lisa Van der Water, The Wine Lab in California)

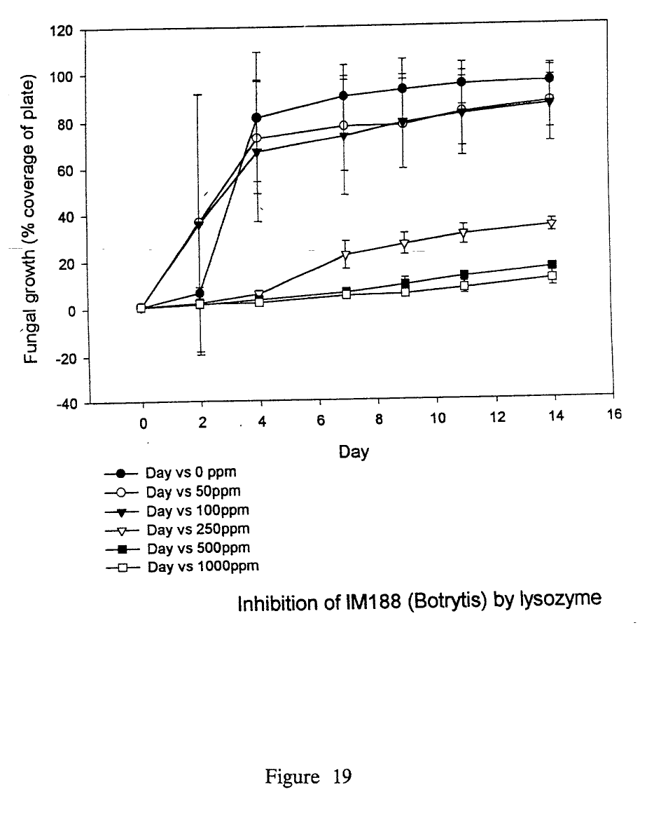

The inhibition of IM113 is presented in FIG. 19. The inhibition of this strain was very effective. At 100 ppm of lysozyme the fungal growth was significantly reduced (p<0.05). The fungal growths on day 14 for the six treatments, 0, 50, 100, 250, 500 and 1000 ppm lysozyme, are 95.9%, 87.2%, 86.2%, 34.0%, 16.4% and 11.3%, respectively. The growth reduction at 500 and 1000 ppm lysozyme is even more efficient than for the other 5 strains.

Lysozyme is very efficient in inhibiting the growth of the six Botrytis strains tested under in vitro condition with PD broth. In general 100 ppm of lysozyme can significantly inhibit the growth for at least 2 weeks.

### Example 10

### Inhibition of Monilinia by Lysozyme

Monilinia is an economically important pathogen for many plants. This fungus causes blighting of leaves and flowers and mummification of fruits. The timing and duration of host susceptibility and pathogen infectivity may vary greatly. The inhibition of growth of Monilinia by lysozyme was tested.

Monilinia was grown in petri dishes on PD agar. Potato dextrose broth was prepared, poured into glass dilution bottles (100 ml each), autoclaved and allowed to cool. Various amounts of lysozyme were added into the broth of 6 treatments (Table 8). Ten ml of the broth from each lysozyme concentration was dispensed into petri dishes. A fungal square (plug) of each culture was cut and placed in/near the center of each plate. Fungal growth was quantified by measuring the diameter of growth of each fungus while it was growing on the liquid media in each petri dish using a ruler. Each treatment was done with triplicates. The experiment was repeated three times (three batches). The observation period for each batch was 2 weeks.

TABLE 8
Treatments for inhibition of Monilinia by lysozyme

| | Lysozyme concentration | Weight of lysozyme for |
|---|---|---|
| Treatment | (ppm) | 100 ml broth (mg) |
| 1 | 0 | 0 |
| 2 | 50 | 5 |
| 3 | 100 | 10 |
| 4 | 250 | 25 |
| 5 | 500 | 50 |
| 6 | 1000 | 100 |

The fungal growth was expressed in % coverage of the petri dishes by the fungal patches. The calculation is presented in the following equation:

Fungal growth (%)=(area of fungal patch/total plate area)×100

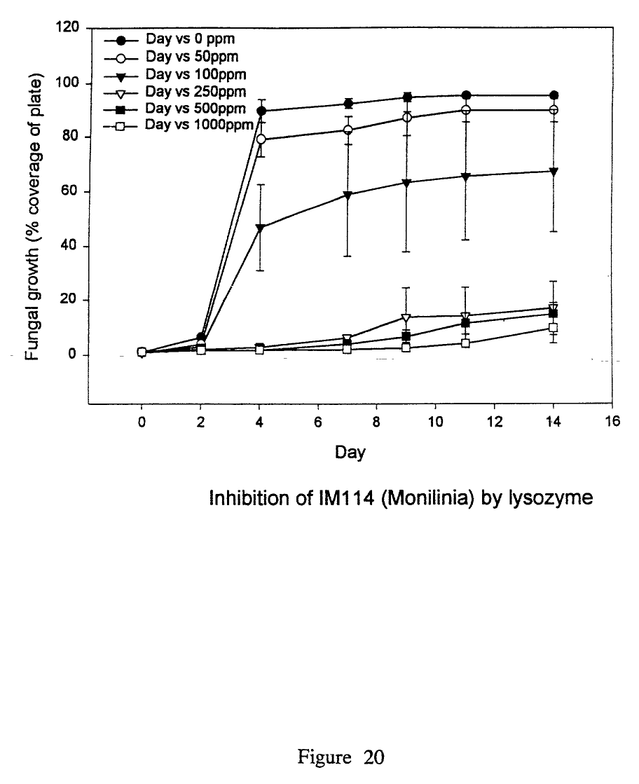

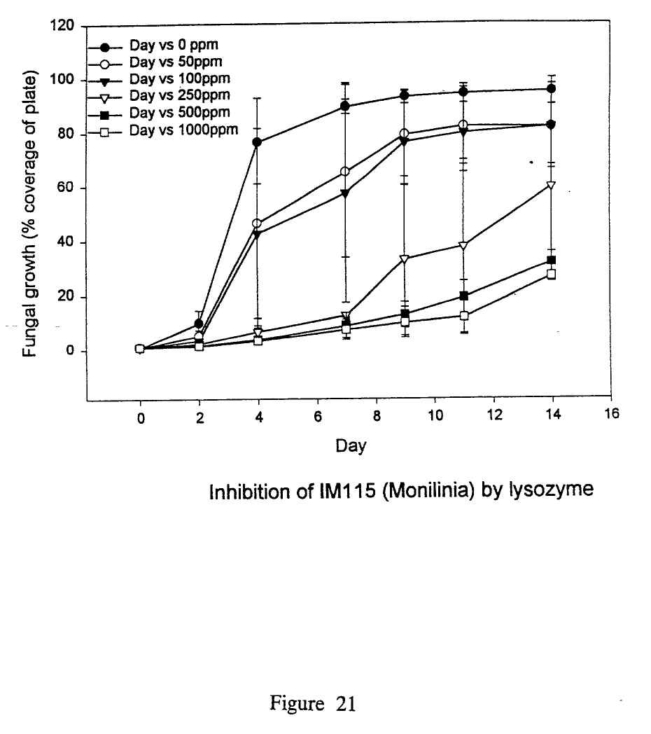

The average plate coverage for the treatments was plotted against the time after inoculation (FIGS. 20 and 21). Statistical analysis was carried out using SigmaStat (Version 2.0, SPSS Science, 1997). From FIGS. 20 and 21, it is clear that lysozyme can effectively inhibit the growth of the 2 Monilinia strains tested. For both pathogens, 100 ppm lysozyme showed significant fungal growth reduction (p<0.05).

Lysozyme is very efficient in inhibiting the growth of the 2 Monilinia strains tested under in vitro condition with PD broth. In general 250-500 ppm of lysozyme can significantly inhibit the growth for at least 2 weeks.

What is claimed is:

1. A method for treating plants, plant tissues and seeds that are infected with one or more fungi or protist pathogens comprising contacting said plants, tissues and seeds with an effective amount of a fungicidal composition comprising egg white lysozyme, wherein the lysozyme in said amount is effective in inhibiting or eradicating said fungi or protist pathogens.

2. The method of claim 1 wherein the fungi and protist pathogens are selected from the group consisting of Curvularia, Monilinia, Sclerotinia homoeocarpa, Fusarium spp, Pythium spp, Phytophthora spp and Botrytis spp.

3. The method of claim 1 wherein the fungicidal composition further comprises an effective amount of a compound selected from the group consisting of avidin, ovotransferrin, chicken immunoglobulins, chitosan, polylysine, protamine, nisin, EDTA, rosemary, cinnemaldehyde, allicin and eugenol.

4. A method for treating plants, plant tissues and seeds that are infected with one or more fungi or protist pathogens comprising contacting said plants, tissues and seeds with an effective amount of a fungicidal composition comprising avidin, wherein the avidin in said amount is effective in inhibiting or eradicating said fungi or protist pathogens.

5. The method of claim 4 wherein the fungicidal composition further comprises an effective amount of a compound selected from the group consisting of lysozyme, ovotransferrin, chicken immunoglobulins, chitosan, polylysine, protamine, nisin, EDTA, rosemary, cinnemaldehyde, allicin and eugenol.

6. A method for treating plants, plant tissues and seeds that are infected with one or more fungi or protist pathogens comprising contacting said plants, tissues and seeds with an effective amount of a fungicidal composition comprising polylysine, wherein the polylysine in said amount is effective in inhibiting or eradicating said fungi or protist pathogens.

7. The method of claim 6 wherein the fungicidal composition further comprises an effective amount of a compound selected from the group consisting of avidin, lysozyme, ovotransferrin, chicken immunoglobulins, chitosan, protamine, nisin, EDTA, rosemary, cinnemaldehyde, allicin and eugenol.

8. A method for preventing fungal or protist infection in plants, plant tissues and seeds comprising contacting said plants, tissues and seeds with an effective amount of a fungicidal composition comprising egg white lysozyme, wherein the lysozyme in said amount is effective to prevent said fungal or protist infection.

9. The method of claim 8 wherein the fungi or protist pathogens are selected from the group consisting of Curvularia, Monilinia, Sclerotinia homoeocarpa, Fusarium spp, Pythium spp, Phytophthora spp and Botrytis spp.

10. The method of claim 8 wherein the fungicidal composition further comprises an effective amount of a compound selected from the group consisting of avidin, ovotransferrin, chicken immunoglobulins, chitosan, polylysine, protamine, nisin, EDTA, rosemary, cinnemaldehyde, allicin and eugenol.

11. A method for preventing fungal or protist infection in plants, plant tissues and seeds comprising contacting said plants, tissues and seeds with an effective amount of a fungicidal composition comprising avidin, wherein the avidin in said amount is effective to prevent said fungal or protist infection.

12. The method of claim 11 wherein the fungicidal composition further comprises an effective amount of a compound selected from the group consisting of lysozyme, ovotransferrin, chicken immunoglobulins, chitosan, polylysine, protamine, nisin, EDTA, rosemary, cinnemaldehyde, allicin and eugenol.

13. A method for preventing fungal or protist infection in plants, plant tissues and seeds comprising contacting said plants, tissues and seeds with an effective amount of a fungicidal composition comprising polylysine, wherein the polylysine in said amount is effective to prevent said fungal or protist infection.

14. The method of claim 13 wherein the fungicidal composition further comprises an effective amount of a compound selected from the group consisting of avidin, lysozyme, ovotransferrin, chicken immunoglobulins, chitosan, protamine, nisin, EDTA, rosemary, cinnemaldehyde, allicin and eugenol.
